(19) United States
(12) Patent Application Publication
(10) Pub. No.: US 2024/0428763 A1
(43) Pub. Date: Dec. 26, 2024

(54) KEYBOARD DEVICE AND ELECTRONIC MUSICAL INSTRUMENT

(71) Applicant: CASIO COMPUTER CO., LTD., Tokyo (JP)

(72) Inventor: Chihaya SAKATA, Tokyo (JP)

(21) Appl. No.: 18/743,816

(22) Filed: Jun. 14, 2024

(30) Foreign Application Priority Data
Jun. 26, 2023 (JP) 2023-104055

(51) Int. Cl. G10H 1/34

(52) U.S. Cl. CPC G10H 1/346; G10H 2220/221; G10H 2220/265

(57) ABSTRACT

The present disclosure relates to a keyboard device and an electronic musical instrument. The keyboard device includes a keyboard including a plurality of keys, a hammer configured to rotate in response to a keyboard operation around an axis in a direction in which the plurality of keys are aligned, and a key press stopper configured to come into contact with the hammer to restrict the rotation of the hammer upon key press. The hammer has a protrusion that protrudes toward a side in which the hammer comes into contact with the key press stopper relative to a contact portion being configured to come into contact with the key press stopper.

### CROSS-REFERENCE TO RELATED APPLICATIONS

This application is based on and claims priority under 35 USC 119 from Japanese Patent Application No. 2023-104055 filed on Jun. 26, 2023, the entire content of which is incorporated herein by reference.

### TECHNICAL FIELD

The present disclosure relates to a keyboard device and an electronic musical instrument.

### Technical Problem

Electronic musical instruments are generally desired to be compact. For this reason, it is desirable that a hammer of the electronic musical instrument is configured to be accommodated in a limited space in the keyboard device, and to reproduce a touch feel similar to that of an acoustic musical instrument by applying a sufficient load to a key press operation.

The present disclosure provides a keyboard device and an electronic musical instrument that are compact and excellent in touch feel upon key press.

### SUMMARY

A keyboard device according to an aspect of the present disclosure includes a keyboard including a plurality of keys, a hammer configured to rotate in response to a keyboard operation around an axis in a direction in which the plurality of keys are aligned, and a key press stopper configured to come into contact with the hammer to restrict the rotation of the hammer upon key press. The hammer has a protrusion that protrudes toward a side in which the hammer comes into contact with the key press stopper relative to a contact portion being configured to come into contact with the key press stopper.

### BRIEF DESCRIPTION OF DRAWINGS

FIG. 1 is a diagram illustrating an example of the external appearance of an electronic musical instrument according to an embodiment;

FIG. 2 is a cross-sectional view upon key press of the keyboard device of the electronic musical instrument according to the embodiment;

FIG. 3 is a cross-sectional view upon key release of the keyboard device of the electronic musical instrument according to the embodiment;

FIG. 4A is a perspective view of a hammer body as viewed obliquely from above;

FIG. 4B is a perspective view of the hammer body as viewed obliquely from below; and

FIG. 4C is a side view of the hammer body.

### DESCRIPTION OF EMBODIMENTS

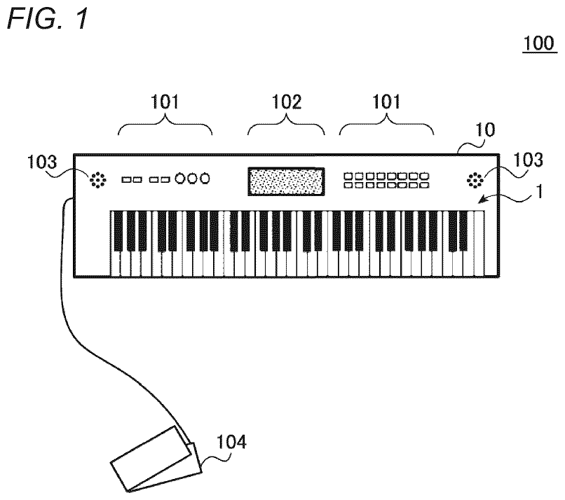

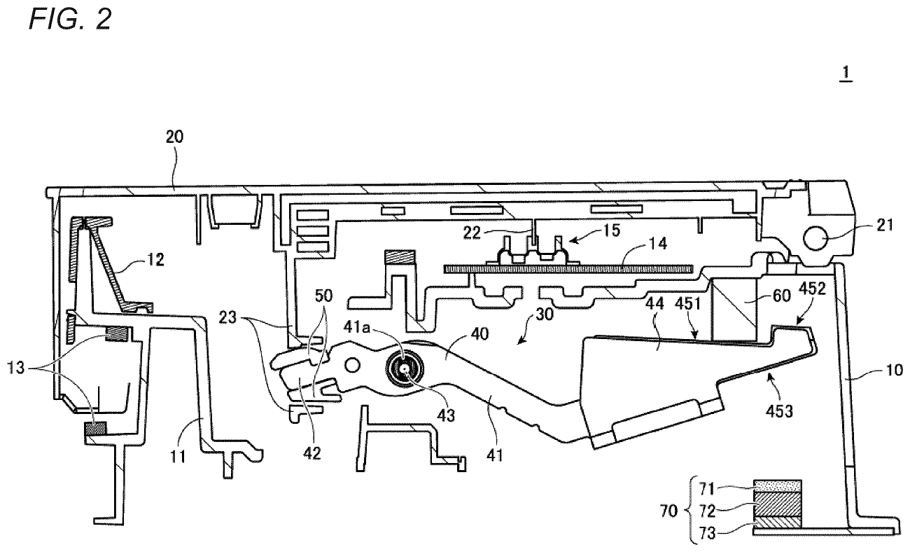

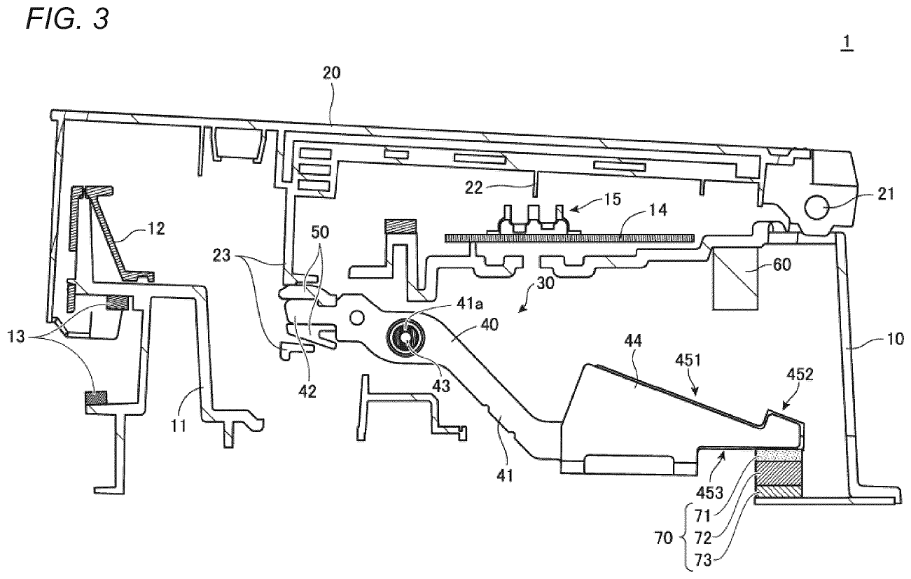

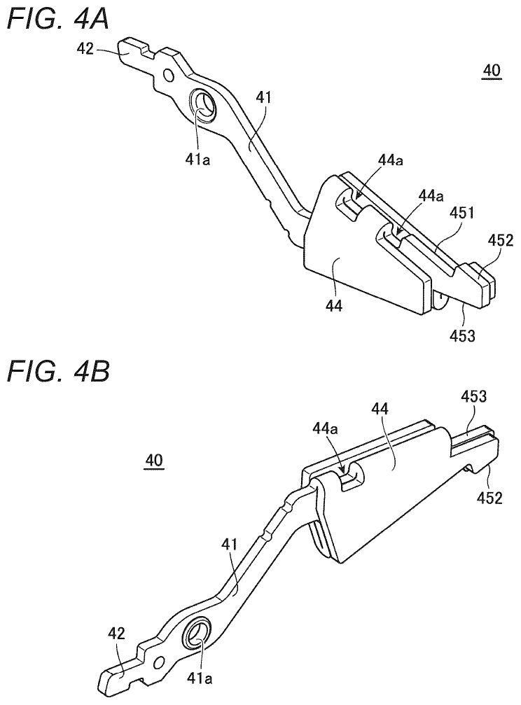

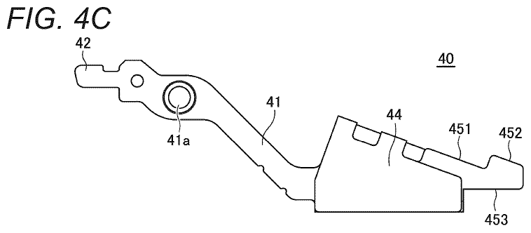

FIG. 1 is a diagram illustrating an example of the external appearance of an electronic musical instrument according to an embodiment. FIG. 2 is a cross-sectional view upon key press of the keyboard device of the electronic musical instrument according to the embodiment. FIG. 3 is a cross-sectional view upon key release of the keyboard device of the electronic musical instrument according to the embodiment. FIG. 4A is a perspective view of a hammer body as viewed obliquely from above. FIG. 4B is a perspective view of the hammer body as viewed obliquely from below. FIG. 4C is a side view of the hammer body. Hereinafter, the configuration of an electronic musical instrument 100 and a keyboard device 1 according to the present embodiment illustrated in FIGS. 1 to 3 will be described with reference to the drawings.

The electronic musical instrument 100 illustrated in FIG. 1 is, for example, an electronic piano or a synthesizer, and includes a keyboard device 1 to be described below in FIGS. 2 to 4C. In addition to the keyboard device 1, the electronic musical instrument 100 may include a switch panel 101, a display 102, a speaker 103, a pedal 104, and the like.

The switch panel 101 may include switches for operations such as designation of the volume, setting of the sound source, the tone, etc., selection (accompaniment) of the song (accompaniment), start/stop of song play, setting of song play (tempo, etc.), and the like. The display 102 may display the lyrics, the musical score, various setting information, and the like. The speaker 103 may be used to emit the sound generated by performance. The pedal 104 may be a sustain pedal having a function of extending the sound of the pressed keyboard while the pedal is stepped on, or may be a pedal for operating an effector that processes the tone, volume, and the like.

The keyboard device 1 is a keyboard device of an electronic musical instrument having a keyboard for designating the pitch, and is, for example, a keyboard device of an electronic piano or a synthesizer. FIGS. 2 and 3 are cross-sectional views in a direction orthogonal to the direction in which the keys 20 included in the keyboard are aligned, and illustrate a situation in which the keyboard device 1 is compact in the front-rear direction of the keys 20.

In the present specification, the direction in which the plurality of keys 20 are aligned is referred to as the width direction of the keyboard device 1, and the front-rear direction of the key 20 is referred to as the depth direction of the keyboard device 1. In the depth direction, the side closer to the user that operates the keyboard device 1 with respect to the keyboard device 1 is referred to as the front side, and the opposite side is referred to as the back side. Further, a direction perpendicular to both the alignment direction and the front-rear direction, in which the key 20 moves up and down, is referred to as the upper-lower direction.

The keyboard device 1 includes a keyboard chassis 10 and a keyboard including the plurality of keys 20. The keys 20 included in the keyboard are supported by the keyboard chassis 10 in a manner rotatable with respect to a widthwise support shaft 21 provided on the back side of the keys 20. The keys 20 each rotate in response to a keyboard operation, that is, a key press or key release operation. The movable range of the key 20 is restricted within a predetermined range by stoppers 13 described later.

The front portion of the keyboard chassis 10 is provided with a front leg 11 protruding toward the keys 20. The upper end of the front leg 11 is provided with a keyboard guide 12 in sliding contact with the keys 20 to prevent the keys 20 from lateral rattling in the width direction. Further, the front leg 11 is provided with stoppers 13 for restricting the upper limit position and the lower limit position when the keys 20 rotate.

A portion facing the keys 20 on the back side of the front leg 11 is attached with a switch board 14. The switch board 14 is provided with switches 15 that are turned on in response to a key press operation to the keys 20. The switches 15 are provided for the keys 20 respectively. Each switch 15 detects a key press operation and outputs an ON signal when a switch protrusion 22 protruding from the bottom of the key 20 toward the keyboard chassis 10 acts on the switch 15 in response to the key press operation. Thus, the electronic musical instrument including the keyboard device 1 generates musical sound information based on the ON signal, and generates musical sound from the speaker 103 based on the musical sound information. A plurality of the switches 15 and a plurality of the switch protrusions 22 may be provided at each of the keys 20.

Inside the keyboard chassis 10, a plurality of hammers 30 corresponding to the plurality of keys 20 are aligned in the width direction. The plurality of hammers 30 are supported by the keyboard chassis 10 in a manner rotatable relative to the shaft 43 which is a shaft extending in the width direction, and rotate around the shaft 43 in response to a keyboard operation.

The inside the keyboard chassis 10 is further provided with a stopper 60 that is a key press stopper for coming into contact with the hammer 30 to restrict the rotation of the hammer 30 upon key press, and a stopper 70 that is a key release stopper for coming into contact with the hammer 30 to restrict the rotation of the hammer 30 upon key release.

Each hammer 30 includes a hammer body 40 and a hammer cap 50. The hammer body 40 includes an arm 41, an effort point 42, and a weight 44. The arm 41 is formed with a shaft hole 41a penetrating in the width direction. The arm 41 is rotatably supported by the keyboard chassis 10 by the shaft 43 inserted into the shaft hole 41a.

The effort point 42 is a part of the hammer body 40 on the front side in the front-rear direction relative to the arm 41 (shaft 43), and functions as an effort point when the hammer body 40 rotates around the shaft 43. The hammer cap 50, which is made of an elastic member such as rubber, is attached to the effort point 42. The lower end of a hammer pressing portion 23 extending from the bottom of the key 20 toward the inside of the keyboard chassis 10 is formed with a through hole opened in a rectangular shape in the front-rear direction. The effort point 42 attached with the hammer cap 50 is inserted into the through hole, thereby coupling the key 20 and the hammer 30.

The weight 44 is the end of the hammer body 40 located on the back side of the arm 41 (shaft 43) in the front-rear direction, and functions as an action point when the hammer body 40 rotates around the shaft 43. As illustrated in FIGS. 2 and 3, the weight 44 has a substantially triangular shape elongated in the front-rear direction when viewed in the axial direction (width direction), and is connected to the arm 41 at the short side portion, which is the front surface among the three surfaces forming the substantially triangular shape.

The arm 41, the effort point 42, and the weight 44 constituting the hammer body 40 are formed by bending a member having a predetermined shape cut out from a flat plate made of a metal having a relatively large specific gravity. Specifically, as illustrated in FIGS. 4A to 4C, the weight 44 has a three-layer structure obtained by folding twice in the front-rear direction at a fold around the portion connected to the arm 41.

Among the plurality of hammer 30, the weight 44 of a hammer 30 on the low-pitch side is made heavier than the weight 44 of a hammer 30 on the high-pitch side. A notch 44a formed in the weight 44 is provided, for example, for adjusting the weight of the hammer 30. In the keyboard device 1, by adjusting the size and the number of the notches 44a, a weight difference is provided between the hammers 30 on the low-pitch side and the high-pitch side. The weight difference between the weight 44 of the hammer 30 on the low-pitch side and the weight 44 of the hammer 30 on the high-pitch side may be provided by a following protrusion 452 not only the notch 44a. A weight of the weight 44 of the hammer 30 on the low-pitch side may be same to a weight of the weight 44 of the hammer 30 on the high-pitch side.

The upper surface among the three surfaces forming the substantially triangular shape of the weight 44 has a substantially flat contact portion 451. When the key 20 is pressed down due to a key press operation, the hammer pressing portion 23 presses the effort point 42 vertically downward. As a result, the hammer 30 rotates with the shaft 43 as the fulcrum, and as illustrated in FIG. 2, the weight 44 is pushed up vertically upward in the keyboard chassis 10. The contact portion 451 is a contact portion that comes into contact with the stopper 60 extending vertically downward from the upper portion of the keyboard chassis 10 when such a key press operation is performed, that is, upon key press.

As illustrated in FIG. 2, the contact portion 451 is preferably formed to be substantially horizontal when coming into contact with the stopper 60. Accordingly, upon key press, the contact portion 451 comes into contact in a wide range with the lower surface of the stopper 60 formed in a substantially flat surface. Therefore, the stopper 60 can firmly absorb the impact on the hammer 30.

In addition to the contact portion 451, the upper surface among the three surfaces forming the substantially triangular shape of the weight 44 further has a protrusion 452 provided to adjust the mass distribution of the hammer 30. As illustrated in FIG. 2, the protrusion 452 is a portion protruding from the contact portion 451 in a direction toward the contact portion 451. In other words, the protrusion 452 is a portion protruding toward the side to come into contact with the stopper 60 relative to the contact portion 451, and can be rephrased as a portion protruding toward the side to come into contact with the stopper 60 with respect to the contact portion 451 or a portion protruding toward the side to come into contact with the stopper 60 with respect to the contact portion 451. The protrusion 452 is provided farther from the shaft 43 than is the contact portion 451.

The protrusion 452 protruding toward the side to come into contact with the stopper 60 allows efficient use of the space in the keyboard device 1, thereby contributing to making the keyboard device 1 compact. Further, arranging the protrusion 452 farther from the shaft 43 than is the contact portion 451 greatly contributes to applying a sufficient moment load to the key 20 while making the keyboard device 1 lightweight and compact. This will be described in detail below.

The stopper 60, which is applied a force corresponding to the key press speed, has such a thickness to firmly absorb the impact even when applied a large force. As a result, the periphery of the stopper 60 is provided with a space approximately corresponding to the thickness of the stopper 60, which has not been utilized in the related art. The arrangement of the protrusion 452 described above, in particular, the arrangement of the protrusion 452 protruding toward the side to come into contact with the stopper 60 effectively utilizes the unused space. Accordingly, since the protrusion 452 for adjusting the mass distribution can be provided without extending the length of the hammer 30 in the front-rear direction, the keyboard device 1 including the hammer 30 with improved touch feel upon key press can be configured compact.

Further, in order to efficiently apply a moment load to the key 20 with the lightweight hammer 30, it is desirable to distribute more mass to a position as far as possible from the shaft 43. In the keyboard device 1, this is achieved by providing the protrusion 452 farther from the shaft 43 than is the contact portion 451. Thus, in the keyboard device 1, a larger moment load can be applied to the hammer 30 than a hammer of the related art having the same weight as the hammer 30. This can give the user a heavier touch feel upon key press. Further, since the protrusion 452 is provided farther than is the contact portion 451, unlike the case where the protrusion 452 is provided on the contact portion 451, the movable range of the hammer 30 is not limited by the protrusion 452.

Accordingly, according to the keyboard device 1 having the hammer 30, it is possible to give the user a heavier touch feel upon key press by the same weight as the related art. Alternatively, it is possible to give the user the same touch feel upon key press while reducing the weight as compared to the related art.

By providing the protrusion 452 farther from the shaft portion 43 than is the contact portion 451, the moment load can be applied efficiently, but it is not desirable to extend the hammer 30 to the back side in the front-rear direction for this purpose. This is because, in an electronic musical instrument configured compact, the extension of the length of the hammer 30 in the front-rear direction may elongated the length of the electronic musical instrument in the depth direction. In the keyboard device 1, the protrusion 452 protrudes from the shaft 43 farther than is the contact portion 451 and toward the side to come into contact with the stopper 60, thereby avoiding the extension of the length of the hammer 30 in the front-rear direction.

As described above, the protrusion 452 is accommodated in the space in the periphery of the stopper 60 generated due to the thickness of the stopper 60 upon key press. In order to avoid contact between the protrusion 452 and the keyboard chassis 10, it is desirable that the length of the protrusion 452 in the upper-lower direction (that is, the protruding amount) is shorter than the length of the stopper 60 in the upper-lower direction (that is, the thickness).

An efficient moment load can be applied as well by the protrusion 452 protruding in the width direction farther from the shaft 43 than is the contact portion 451. However, the configuration protruding in the width direction interferes with the adjacent hammer 30 and thus is not desirable.

The lower surface among the three surfaces forming the substantially triangular shape of the weight 44 has a substantially flat contact portion 453. When the pressure to the key 20 is released by a key release operation, the weight 44 falls vertically downward due to its own weight. As a result, the hammer 30 rotates with the shaft 43 as the fulcrum, and as illustrated in FIG. 3, the weight 44 comes into contact with the stopper 70. The contact portion 453 is a contact portion that comes into contact with the stopper 70 extending vertically upward from the lower portion of the keyboard chassis 10 when such a key release operation is performed, that is, upon key release.

As illustrated in FIG. 3, the contact portion 453 is preferably formed to be substantially horizontal when coming into contact with the stopper 70. Accordingly, upon key release, the contact portion 453 comes into contact in a wide range with the upper surface of the stopper 70 formed in a substantially flat surface. Therefore, the stopper 70 can firmly absorb the impact on the hammer 30.

The contact portion 453 is configured as a recess recessed relative to the other portions of the lower surface. That is, the hammer 30 has the contact portion 453, which is a recess to come into contact with the stopper 70 on the side to come into contact with the stopper 70. Configuring the contact portion 453 as a recess greatly contributes to preventing the hammer 30 from bounding upon key release. This will be described in detail below.

Various convenience may occur if the stopper 70 cannot stop the force of the hammer 30 upon key release and the hammer 30 bounds on the stopper 70. Typical examples thereof include deterioration in the followability to the movement of the finger when the keys 20 are struck repeatedly, unnecessary vibrations transmitted to the fingers causing deterioration in the comfort, and twice sounding upon a single key press. These tend to occur more significantly as the electronic musical instrument is configured compact.

In order to prevent the hammer 30 from bounding upon key release, it is desirable to increase the thickness of the stopper 70. In the keyboard device 1, by configuring the contact portion 453 as a recess, it is possible to secure a larger space that can be used for the stopper 70 without changing the movable range of the hammer 30, thereby allowing to arrange a thicker stopper 70 than in the related art. As a result, in the keyboard device 1, the stopper 70 can be configured thick, and the vibration damping performance upon key release is improved. This can prevent the hammer 30 from bounding, thereby avoiding the occurrence of various inconvenience associated with the bounding.

The stopper 70 has a three-layer structure including a silencing layer 71, a buffer layer 72, and a base layer 73 in this order from the side to come into contact with the hammer 30. The silencing layer 71 is a layer for reducing collision noise between the hammer 30 and the stopper 70, and is formed of, for example, a material such as a polyester felt. The buffer layer 72 is a layer for exhibiting a buffering effect, and is formed of, for example, an elastic material for preventing the hammer 30 from bounding, such as rubber. The buffer layer 72 is preferably made of a material that exhibits performance in a wide range from a low temperature to a normal temperature. The base layer 73 is a layer for preventing collision noise from being transmitted to the keyboard chassis 10 and echoing. The stopper 70 may be thicker than the stopper 60.

In the keyboard device 1, in order to prevent the hammer 30 from bounding, it is desirable to configure the contact portion 453 as a recess to use the secured space for increasing the thickness of the buffer layer 72. More specifically, the buffer layer 72 is preferably thicker than the silencing layer 71 and thicker than the base layer 73. As a result, since the effect of preventing the hammer 30 from bounding is more efficiently improved by increasing the thickness of the stopper 70, the hammer 30 can be prevented from bounding without excessively increasing the thickness of the stopper 70 while saving space.

In the keyboard device 1, it is preferable that the stopper 70 is provided farther from the shaft 43 than is the stopper 60. By providing the stopper 70 farther from the shaft 43 than is the stopper 60, the protrusion 452, which is provided farther than is the contact portion 451 to come into contact with the stopper 60, is positioned approximately above the contact portion 453 to come into contact with the stopper 70. With such a positional correlation, the stopper 70 can firmly absorb an impact generated by the protrusion 452 upon key release, so that the occurrence of bounding can be efficiently prevented.

In the keyboard device 1 configured as described above, the protrusion 452 for adjusting the mass distribution in the hammer 30 is provided farther from the shaft 43 than is the contact portion 451. This can efficiently apply the moment load to the key 20 with respect to the weight of the hammer 30. In addition, by the protrusion 452 protruding to the side to come into contact with the stopper 60, the space in the keyboard device 1 can be effectively utilized, thereby avoiding an increase in the size of the keyboard device 1. Accordingly, according to the keyboard device 1, it is possible to realize a lightweight and compact keyboard device excellent in touch feel upon key press, and is particularly suitable for use in an electronic musical instrument such as an electronic piano.

As compared to a weight of the related art having a triangular shape without the protrusion 452 or the recess (contact portion 453), the weight 44 of the keyboard device 1 can be regarded as having a mass at a position corresponding to the contact portion 453 of the weight of the related art moved to a position corresponding to the protrusion 452. Since the hammer 30 has the center of gravity in a region closer to the arm 41 in the weight 44, the protrusion 452 and the contact portion 453 have approximately the same distance from the center of gravity, and the movement of the mass from the contact portion 453 to the protrusion 452 hardly affects the position of the center of gravity. Since the hammer 30 having the protrusion 452 and the contact portion 453 has the center of gravity at approximately the same position as the hammer of the related art, it is also desirable to avoid a change in touch feel caused by a change in the position of the center of gravity.

The embodiments described above are specific examples for facilitating understanding of the present disclosure, and the present disclosure is not limited to these embodiments but should be understood to include various modifications and alternative forms of the embodiments described above. For example, it should be understood that the embodiments described above can be embodied by modifying the components without departing from the gist thereof. Further, it should be understood that various modes may be carried out by suitably combining a plurality of components disclosed in the embodiments described above. Further, it will be understood by those skilled in the art that various embodiments may be implemented by deleting a part of components from all the components shown in the embodiments or adding a part of components to the components shown in the embodiments. That is, the keyboard device and the electronic musical instrument described above can be variously modified and changed without departing from the scope of the claims. In the above-described embodiment, the protrusion 452 is provided closer to the stopper 60, that is, provided in the upper space, but may be provided at any position that can effectively utilize the space in the keyboard device 1, for example, closer to the stopper 70, that is, in the lower space.

What is claimed is:

1. A keyboard device comprising:
a keyboard including a plurality of keys;
a hammer configured to rotate in response to a keyboard operation around an axis in a direction in which the plurality of keys are aligned; and
a key press stopper configured to come into contact with the hammer to restrict the rotation of the hammer upon key press,
wherein the hammer has a protrusion that protrudes toward a side in which the hammer comes into contact with the key press stopper relative to a contact portion being configured to come into contact with the key press stopper.

2. The keyboard device according to claim 1,
wherein the hammer has the protrudes farther from the shaft than the contact portion.

3. The keyboard device according to claim 1,
wherein a length in an upper-lower direction of the protrusion is shorter than a length in the upper-lower direction of the key press stopper.

4. The keyboard device according to claim 2,
wherein a length in an upper-lower direction of the protrusion is shorter than a length in the upper-lower direction of the key press stopper.

5. The keyboard device according to claim 1, further comprising:
a key release stopper configured to come into contact with the hammer to restrict the rotation of the hammer upon key release,
wherein the hammer further has a recess configured to come into contact with the key release stopper on a side configured to come into contact with the key release stopper.

6. The keyboard device according to claim 2, further comprising:
a key release stopper configured to come into contact with the hammer to restrict the rotation of the hammer upon key release,
wherein the hammer further has a recess configured to come into contact with the key release stopper on a side configured to come into contact with the key release stopper.

7. The keyboard device according to claim 5,
wherein the recess is provided at a position correspond to the protrusion in a depth direction of the keyboard device.

8. The keyboard device according to claim 1, further comprising:
a key release stopper configured to come into contact with the hammer to restrict the rotation of the hammer upon key release,
wherein the key release stopper has a three-layer structure including a silencing layer, a buffer layer, and a base layer in order from a side configured to come into contact with the hammer, and
wherein the buffer layer is thicker than the silencing layer and thicker than the base layer.

9. The keyboard device according to claim 6,
wherein the key release stopper is thicker than the key press stopper.

10. The keyboard device according to claim 1, further comprising:
a key release stopper configured to come into contact with the hammer to restrict the rotation of the hammer upon key release,
wherein the key release stopper is provided farther from the shaft than is the key press stopper.

11. An electronic musical instrument comprising the keyboard device according to claim 1.
